(19) United States
(12) Patent Application Publication
(10) Pub. No.: US 2025/0296573 A1
(43) Pub. Date: Sep. 25, 2025

(54) METHODS AND SYSTEMS FOR ESTIMATING LATERAL ADHESION OF VEHICLE TIRES

(71) Applicant: GM GLOBAL TECHNOLOGY OPERATIONS LLC, Detroit, MI (US)

(72) Inventors: Yubiao Zhang, Sterling Heights, MI (US); Bo Yu, Novi, MI (US); Erick Mauricio Via Lopez, Ann Arbor, MI (US); Hualin Tan, Novi, MI (US)

(73) Assignee: GM GLOBAL TECHNOLOGY OPERATIONS LLC, Detroit, MI (US)

(21) Appl. No.: 18/611,493

(22) Filed: Mar. 20, 2024

(51) Int. Cl. B60W 40/064; B60W 40/101

(52) U.S. Cl. CPC B60W 40/064; B60W 40/101

(57) ABSTRACT

Methods and systems are provided for estimating lateral adhesion of vehicle tires are provided. The methods include receiving sensor signals, processing the signals to estimate a self-aligning torque (SAT) rate, a lateral force rate, and a slip angle rate, performing a state synchronize process to reduce a time mismatch between the lateral force rate and the slip angle rate, performing a filtering process to provide a lateral slope estimation and a SAT slope estimation, performing a normalization process on the lateral slope estimation and the SAT slope estimation, classifying the normalized SAT slope estimation, and performing an arbitration and fusion process to adjust the normalized lateral slope estimation based on the classification of the normalized SAT slope estimation to estimate a final lateral adhesion level indicator.

### INTRODUCTION

The technical field generally relates to tire lateral adhesion of a vehicle and more particularly relates to systems and methods for estimating lateral adhesion for a vehicle with consideration of a self-aligning torque (SAT) slope estimation.

Tire lateral adhesion refers to the tire's ability to maintain grip and traction when a vehicle is making lateral movements, such as cornering or changing lanes. Several factors may contribute to tire lateral adhesion, including specific tire parameters (e.g., material, size/shape, tread depth/design, internal pressure, internal structure, etc.), vehicle parameters (e.g., suspension system, current speed and tire camber angle, vertical load, etc.), and driving conditions (e.g., road surface, weather conditions, temperature, etc.).

A tire lateral adhesion limit indicates a maximum lateral force upon the tires before sliding occurs. Certain modern vehicle systems may use this limit when implementing various vehicle control features, such as steering assistance. Accordingly, it is desirable to provide systems and methods that promote accurate and efficient estimation of the tire lateral adhesion limit during operation of a vehicle. Furthermore, other desirable features and characteristics of the present disclosure will become apparent from the subsequent detailed description and the appended claims, taken in conjunction with the accompanying drawings and the foregoing introduction.

### SUMMARY

A method is provided for estimating a final lateral adhesion level indicator of tires for a vehicle traveling on tires. In one example, the method includes, with one or more processors of a controller onboard the vehicle: receiving signals from an onboard sensor system of the vehicle indicative of operating parameters of the vehicle, processing the signals to estimate a self-aligning torque rate, a lateral force rate, and a slip angle rate, performing a state synchronize process to reduce a time mismatch between the lateral force rate and the slip angle rate and thereby provide a synchronized slip angle rate, performing a filtering process to provide a lateral slope estimation and a self-aligning torque slope estimation each based on the self-aligning torque rate, the lateral force rate, and the synchronized slip angle rate, performing a normalization process to reduce noise associated with the lateral slope estimation and the self-aligning torque slope estimation and thereby produce a normalized lateral slope estimation and a normalized self-aligning torque slope estimation, classifying the normalized self-aligning torque slope estimation, and performing an arbitration and fusion process to adjust the normalized lateral slope estimation based on the classification of the normalized self-aligning torque slope estimation to estimate the final lateral adhesion level indicator.

In various examples, the operating parameters used in the method include a lateral force, a steering torque, a longitudinal speed, a lateral acceleration, a yaw rate, steering angles, and various vehicle parameters.

In various examples, processing the signals to estimate the self-aligning torque rate is based on a total torque received from a controller area network of the vehicle, a self-aligning torque of the tires, a position and a velocity of the tires, a lumped mass of a steering system of the vehicle, and a lumped dampening of the vehicle.

In various examples, processing the signals to estimate the lateral force rate is based on lateral forces of the tires, vertical forces of the tires, and a steering road wheel angle.

In various examples, processing the signals to estimate the slip angle rate is based on a longitudinal speed, a lateral acceleration, a yaw rate, one or more vehicle parameters, and a steering wheel angle.

In various examples, performing the filtering process to provide the lateral slope estimation and the self-aligning torque slope estimation includes using a recursive least square estimator or a Kalman filter.

In various examples, performing the normalization process to reduce the noise associated with the lateral slope estimation and the self-aligning torque slope estimation includes consideration of road conditions.

A system is provided for a vehicle. In one example, the system includes a sensor system configured to sense observable conditions of an environment exterior to the vehicle, an interior environment of the vehicle, and/or a condition of one or more components of the vehicle, and a controller configured to, with one or more processors: receive signals from the sensor system indicative of operating parameters of the vehicle while traveling on tires, process the signals to estimate a self-aligning torque rate, a lateral force rate, and a slip angle rate, perform a state synchronize process to reduce a time mismatch between the lateral force rate and the slip angle rate and thereby provide a synchronized slip angle rate, perform a filtering process to provide a lateral slope estimation and a self-aligning torque slope estimation each based on the self-aligning torque rate, the lateral force rate, and the synchronized slip angle rate, perform a normalization process to reduce noise associated with the lateral slope estimation and the self-aligning torque slope estimation and thereby produce a normalized lateral slope estimation and a normalized self-aligning torque slope estimation, classify the normalized self-aligning torque slope estimation, and perform an arbitration and fusion process to adjust the normalized lateral slope estimation based on the classification of the normalized self-aligning torque slope estimation to estimate a final lateral adhesion level indicator.

In various examples, the operating parameters used by the controller of the system include a lateral force, a steering torque, a longitudinal speed, a lateral acceleration, a yaw rate, steering angles, and various vehicle parameters.

In various examples, the controller of the system is configured to, by the one or more processors, process the signals to estimate the self-aligning torque rate based on a total torque received from a controller area network of the vehicle, a self-aligning torque of the tires, a position and a velocity of the tires, a lumped mass of a steering system of the vehicle, and a lumped dampening of the vehicle.

In various examples, the controller of the system is configured to, by the one or more processors, process the signals to estimate the lateral force rate based on lateral forces of the tires, vertical forces of the tires, and a steering road wheel angle.

In various examples, the controller of the system is configured to, by the one or more processors, process the signals to estimate the slip angle rate based on a longitudinal speed, a lateral acceleration, a yaw rate, one or more vehicle parameters, and a steering wheel angle.

In various examples, the controller of the system is configured to, by the one or more processors, perform the filtering process to provide the lateral slope estimation and the self-aligning torque slope estimation using a recursive least square estimator or a Kalman filter.

In various examples, the controller of the system is configured to, by the one or more processors, perform the normalization process to reduce the noise associated with the lateral slope estimation and the self-aligning torque slope estimation with consideration of road conditions.

A vehicle is provided that, in one example, includes a sensor system configured to sense observable conditions of an environment exterior to the vehicle, an interior environment of the vehicle, and/or a condition of one or more components of the vehicle, and a controller configured to, with one or more processors: receive signals from the sensor system indicative of operating parameters of the vehicle while traveling on tires, process the signals to estimate a self-aligning torque rate, a lateral force rate, and a slip angle rate, perform a state synchronize process to reduce a time mismatch between the lateral force rate and the slip angle rate and thereby provide a synchronized slip angle rate, perform a filtering process to provide a lateral slope estimation and a self-aligning torque slope estimation each based on the self-aligning torque rate, the lateral force rate, and the synchronized slip angle rate, perform a normalization process to reduce noise associated with the lateral slope estimation and the self-aligning torque slope estimation and thereby produce a normalized lateral slope estimation and a normalized self-aligning torque slope estimation, classify the normalized self-aligning torque slope estimation, and perform an arbitration and fusion process to adjust the normalized lateral slope estimation based on the classification of the normalized self-aligning torque slope estimation to estimate a final lateral adhesion level indicator.

In various examples, the operating parameters used by the controller of the vehicle include a lateral force, a steering torque, a longitudinal speed, a lateral acceleration, a yaw rate, steering angles, and various vehicle parameters.

In various examples, the controller of the vehicle is configured to, by the one or more processors, process the signals to estimate the self-aligning torque rate based on a total torque received from a controller area network of the vehicle, a self-aligning torque of the tires, a position and a velocity of the tires, a lumped mass of a steering system of the vehicle, and a lumped dampening of the vehicle.

In various examples, the controller of the vehicle is configured to, by the one or more processors, process the signals to estimate the lateral force rate based on lateral forces of the tires, vertical forces of the tires, and a steering road wheel angle.

In various examples, the controller of the vehicle is configured to, by the one or more processors, process the signals to estimate the slip angle rate based on a longitudinal speed, a lateral acceleration, a yaw rate, one or more vehicle parameters, and a steering wheel angle.

In various examples, the controller of the vehicle is configured to, by the one or more processors, perform the normalization process to reduce the noise associated with the lateral slope estimation and the self-aligning torque slope estimation with consideration of road conditions.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of an exemplary vehicle having an estimation system in accordance with an example;

FIG. 2 is a dataflow diagram of the estimation system of FIG. 1 in accordance with an example;

FIG. 3 is an algorithm for estimating a self-aligning torque rate with the estimation system of FIG. 1 in accordance with an example;

FIG. 4 is a dataflow diagram of a lateral force rate estimation submodule in accordance with an example;

FIG. 5 is a dataflow diagram of a slip angle rate estimation submodule in accordance with an example;

FIG. 6 is a line graph presenting an estimated lateral force rate and an estimated slip angle rate for an exemplary vehicle during a slalom maneuver in accordance with an example;

FIG. 7 is a flowchart illustrating a method for synchronizing the lateral force rate and the slip angle rate of an exemplary vehicle and thereby providing a synchronized slip angle rate in accordance with an example;

FIG. 8 is a dataflow diagram of a lateral slope estimation submodule in accordance with an example;

FIG. 9 is a flowchart illustrating a method for normalizing the estimated lateral slope of a vehicle in accordance with an example;

FIG. 10 is a flowchart illustrating a method for classification of the SAT rate of a vehicle in accordance with an example;

FIG. 11 is a flowchart illustrating a method for estimating final lateral adhesion levels for a vehicle in accordance with an example; and

FIG. 12 is a flowchart illustrating a method for estimating lateral adhesion level indicators for tires of a vehicle in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Examples of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that examples of the present disclosure may be practiced in conjunction with any number of systems, and that the systems described herein are merely examples of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example of the present disclosure.

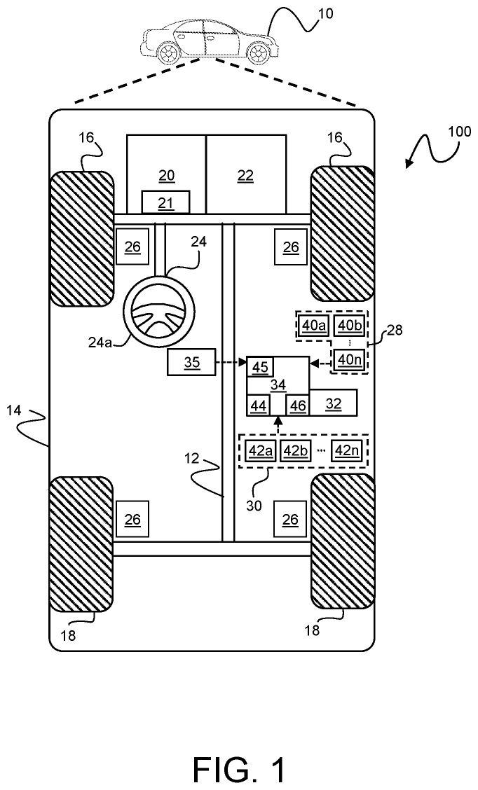

FIG. 1 illustrates a vehicle 10, according to an example. The vehicle 10 includes an estimation system 100 for estimating lateral adhesion of tires of a vehicle with consideration of a self-aligning torque (SAT) slope estimation. In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

The vehicle 10 further includes a propulsion system 20, a transmission system 22, a steering system 24, a braking system 26, a sensor system 28, an actuator system 30, at least one data storage device 32, at least one controller 34, and a steering assistance system 35. The propulsion system 20 includes an engine and/or motor 21 such as an internal combustion engine (e.g., a gasoline or diesel fueled combustion engine), an electric motor (e.g., a 3-phase AC motor), or a hybrid system that includes more than one type of engine and/or motor. The transmission system 22 is configured to transmit power from the propulsion system 20 to the wheels 16-18 according to selectable speed ratios. According to various examples, the transmission system 22 may include a step-ratio automatic transmission, a continuously-variable transmission, or other appropriate transmission. The steering system 24 influences positions of the wheels 16-18. While depicted as including a steering wheel 24a for illustrative purposes, in some examples contemplated within the scope of the present disclosure, the steering system 24 may not include a steering wheel. The wheels 16-18 include tires configured to contact a roadway or other surface.

The sensor system 28 includes one or more sensing devices 40a-40n that sense observable conditions of the exterior environment, the interior environment, and/or a status or condition of a corresponding component of the vehicle 10 and provide such condition and/or status to other systems of the vehicle 10, such as the controller 34. It should be understood that the vehicle 10 may include any number of the sensing devices 40a-40n. The sensing devices 40a-40n can include, but are not limited to, current sensors, voltage sensors, temperature sensors, motor speed sensors, position sensors, speed sensors, acceleration sensors, etc.

The actuator system 30 includes one or more actuator devices 42a-42n that control one or more vehicle features such as, but not limited to, the propulsion system 20, the transmission system 22, and/or the steering system 24.

The data storage device 32 stores data for use in controlling the vehicle 10 and/or systems and components thereof. As can be appreciated, the data storage device 32 may be part of the controller 34, separate from the controller 34, or part of the controller 34 and part of a separate system. The storage device 32 can be any suitable type of storage apparatus, including various different types of direct access storage and/or other memory devices. In one example, the storage device 32 comprises a program product from which a computer readable memory device can receive a program that executes one or more examples of one or more processes of the present disclosure. In another example, the program product may be directly stored in and/or otherwise accessed by the memory device and/or one or more other disks and/or other memory devices.

The controller 34 includes at least one processor 44, a communication bus 45, and a computer readable storage device or media 46. The processor 44 performs the computation and control functions of the controller 34. The processor 44 can be any custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (erasable PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle 10. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms, and generate data based on the logic, calculations, methods, and/or algorithms. Although only one controller 34 is shown in FIG. 1, examples of the vehicle 10 can include any number of controllers 34 that communicate over any suitable communication medium or a combination of communication mediums and that cooperate to process the sensor signals, perform logic, calculations, methods, and/or algorithms, and generate data.

As can be appreciated, the controller 34 may otherwise differ from the example depicted in FIG. 1. For example, the controller 34 may be coupled to or may otherwise utilize one or more remote computer systems and/or other control systems, for example as part of one or more of the above-identified vehicle devices and systems. It will be appreciated that while this example is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain examples. It will similarly be appreciated that the computer system of the controller 34 may also otherwise differ from the example depicted in FIG. 1, for example in that the computer system of the controller 34 may be coupled to or may otherwise utilize one or more remote computer systems and/or other control systems.

The braking system 26 is configured to provide braking torque, pressure, or force to the wheels 16-18. The braking system 26 may, in various examples, include friction brakes, brake by wire, a regenerative braking system such as an electric machine, and/or other appropriate braking systems. In one example, the vehicle 10 includes the brake pedal 31, which is movable by the operator from a released position into a depressed position to activate the braking system 26 to apply the braking torque (i.e., pressure or force).

The driving assistance system 36 may include various software and/or hardware components configured to provide driving assistance by automatically controlling, for example, one or more of the actuator devices 42a-42n and thereby control vehicle acceleration, steering, and/or braking without user intervention, or otherwise adjust acceleration, steering, and/or braking input by the user. In some examples, the driving assistance system 36 may include an all-wheel drive (AWD) system, a torque vectoring system, an electric power steering (EPS) system, and/or an active rear steering (ARS) system.

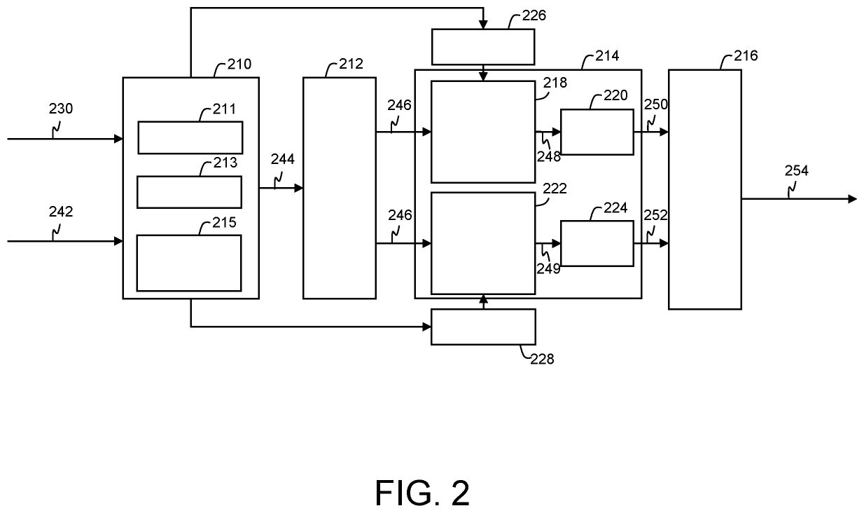

With reference to FIG. 2 and with continued reference to FIG. 1, a dataflow diagram illustrates elements of the estimation system 100 of FIG. 1 in accordance with various examples. As can be appreciated, various examples of the estimation system 100 according to the present disclosure may include any number of modules embedded within the controller 34 which may be combined and/or further partitioned to similarly implement systems and methods described herein. Furthermore, inputs to the estimation system 100 may be received from other control modules (not shown) associated with the vehicle 10, and/or determined/modeled by other sub-modules (not shown) within the controller 34. Furthermore, the inputs might also be subjected to preprocessing, such as sub-sampling, noise-reduction, normalization, feature-extraction, missing data reduction, and the like. In various examples, the estimation system 100 includes a signal conditioning module 210, a state synchronization module 212, a slope estimation module 214, and an arbitration and fusion module 216.

In various examples, the signal conditioning module 210 receives as input various data indicative of operating parameters and vehicle parameters of the vehicle 10. In the example of FIG. 2, the signal conditioning module 210 receives sensor data 230 generated by the sensor system 28 and vehicle parameter data 242 retrieved from a data storage device (e.g., the data storage device 32). The sensor data 230 includes various data indicating, for example, lateral force on the tires as sensed by a lateral force sensor, steering torque of the vehicle 10 as sensed by a steering torque sensor, longitudinal speed of the vehicle 10 as sensed by a speed sensor, lateral acceleration of the vehicle 10 as sensed by an acceleration sensor, yaw rate of the vehicle 10 as sensed by a yaw rate sensor, and steering angles of the vehicle 10 as sensed by steering angle sensors. The vehicle parameter data 242 includes various data indicating certain aspects of the vehicle 10, such as vehicle mass, distances from the vehicle's center of gravity (CG) to centers of the front and rear axles, etc.

The signal conditioning module 210 processes the sensor data 230 and the vehicle parameter data 242 to estimate a self-aligning torque (SAT) rate, a lateral force rate, and a slip angle rate of the vehicle 10. In some examples, these processes may be performed by a SAT rate estimation submodule 211, a lateral force rate estimation submodule 213, and a slip angle rate estimation submodule 215.

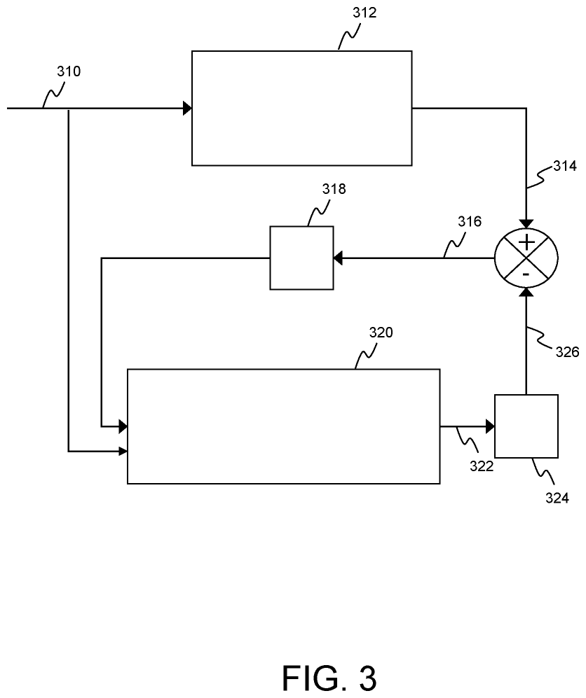

FIG. 3 illustrates an exemplary algorithm, in view of the equations 1-3 below, for use in the operation of the SAT rate estimation submodule 211 for estimating the SAT rate. In this example, reference number 310 represents u, reference number 312 represents equation 2 below, reference number 314 represents y, reference number 316 represents e, reference number 318 represents an observer gain (L), reference number 320 represents equation 3 below, reference number 322 represents estimated SAT of the tires, steering system position and velocity, (\hat{x}; optionally, less the friction torque), reference number 324 represents C, and reference number 326 represents ŷ. In equations 1-3 below, Tₜₒₜₐₗ represents a total torque received from a controller area network (CAN) of the vehicle 10, Tᵣ represents a SAT of the tires (optionally, with the friction torque if available (e.g., Tᵣ=SAT+friction torque), xᵣ and \dot{x}ᵣ represent a position and a velocity of the steering system, respectively, mᵣ represents a lumped mass of a steering system 24 of the vehicle 10, bᵣ represents a lumped dampening of the steering system 24 of the vehicle 10. The observer gain (L) may be set using pole placement, optimal, and/or robust filter methods. With the algorithm illustrated in FIG. 3, the SAT and the SAT rate may be accurately estimated by comparing the estimated and measured signals and adjusting the state estimation using the observer gain (L).

$$\{ \begin{matrix}{\underbrace{[ \begin{matrix}\begin{matrix}\dot{{x}_{r}} \\ \ddot{{x}_{r}}\end{matrix} \\ \dot{{T}_{r}}\end{matrix} ]}}_{\dot{x}} = {\underbrace{[ \begin{matrix}0 & 1 & 0 \\ 0 & - \frac{{b}_{r}}{{m}_{r}} & - \frac{1}{{m}_{r}} \\ 0 & 0 & 0\end{matrix} ]}}_{A} {\underbrace{[ \begin{matrix}\begin{matrix}{x}_{r} \\ \dot{{x}_{r}}\end{matrix} \\ {T}_{r}\end{matrix} ]}}_{x} + {\underbrace{[ \begin{matrix}\begin{matrix}0 \\ \frac{1}{{m}_{r}}\end{matrix} \\ 0\end{matrix} ]}}_{B} {\underbrace{{T}_{total}}}_{u} \\ y = {\underbrace{[ \begin{matrix}\begin{matrix}1 & 0\end{matrix} & 0\end{matrix} ]}}_{c} {\underbrace{[ \begin{matrix}\begin{matrix}{x}_{r} \\ \dot{{x}_{r}}\end{matrix} \\ {T}_{r}\end{matrix} ]}}_{x}\end{matrix} \qquad eq . 1$$

$$\dot{x} = Ax + Bu \qquad eq . 2$$

$$y = Cx$$

$${x}^{\dot{\hat{}}} = A \hat{x} + Bu + L ( y - \hat{y} ) \qquad eq . 3$$

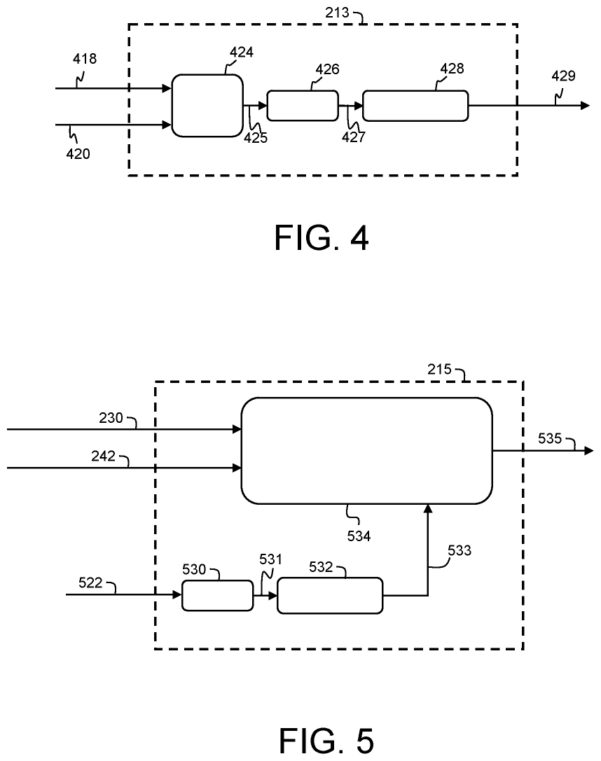

FIG. 4 illustrates an exemplary operation of the lateral force rate estimation submodule 213 for estimating the lateral force rate of the rear tires (Fy_{R} rate). In this example, a first Fy submodule 424 receives lateral force data 418 indicating the lateral force in the y-direction (Fy) of the left rear tire (LR) and the right rear tire (RR) and vertical force data 420 indicating the vertical force in the z-direction (Fz) of the left rear tire (LR) and the right rear tire (RR). The first Fy submodule 424 differentiates the lateral forces of the rear tires (Fy(LR,RR)) with respect to the vertical forces of the rear tires (Fz(LR,RR) to produce a first derivative (d/dFz). The first Fy submodule 424 outputs first result data 425 indicating the first derivative (d/dFz). The first result data 425 is received by a second Fy submodule 426 that then differentiates the first derivative (d/dFz) with respect to time to produce a second derivative (d/dt). The second Fy submodule 426 outputs second result data 427 indicating the second derivative (d/dt). The second result data 427 is received by a third Fy submodule 428 which may apply a low pass filter to the second derivative to estimate the lateral force rate in the y-direction for the rear tires. The third Fy submodule 428 may output estimated lateral force rate data 429 indicating the estimated lateral force rate for the rear tires (Fy_{R} rate). This operation may be repeated for the front tires using the lateral force (Fy) and the vertical force (Fz) on the front left tire (LF) and the front right tire (RF) to estimate the lateral force rate for the from tires (Fy_{F} rate).

FIG. 5 illustrates an exemplary operation of the slip angle rate estimation submodule 215 for estimating the slip angle rate for the rear tires (\dot{α}R). In this example, a first α submodule 530 receives rear angle data 522 indicating a rear steering road wheel angle (RWA). The first α submodule 530 differentiates the rear steering road wheel angle (RWA) with respect to time (t) to produce a first derivative (d/dt). The first α submodule 530 outputs first result data 531 indicating the first derivative (d/dt). A second α submodule 532 receives the first result data 531 and may apply a low pass filter to the first derivative (d/dt) to estimate the rear steering road wheel angle rate (δᵣ). The second α submodule 532 may output second result data 533 indicating the estimated rear steering road wheel angle rate (δᵣ). A third α submodule 534 receives the second result data 533 from the second α submodule 532, and receives the sensor data 230 indicating the longitudinal speed (Vₓ), the lateral acceleration (A_{y}), the yaw rate (r), and the yaw acceleration (\dot{r}), and the vehicle parameter data 242 to estimate the slip angle rate of the rear tires (\dot{α}_{R}). In some examples, the third α submodule 534 may use equation 4 below.

$${\dot{α}}_{R} = \frac{( {α}_{y} - {L}_{r} \dot{r} )}{{V}_{x}} - r - {\dot{δ}}_{r} \qquad eq . 4$$

The third α submodule 534 may output estimated slip angle rate data 535 indicating the estimated slip angle rate of the rear tires. This operation may be repeated for the front tires using the front steering road wheel angle (RWA) to estimate the slip angle rate of the front tires (\dot{α}_{F}).

The signal conditioning module 210 generates conditioned input data 244 indicating the estimated self-aligning torque rate, estimated lateral force rate, and estimated slip angle rate of the vehicle 10.

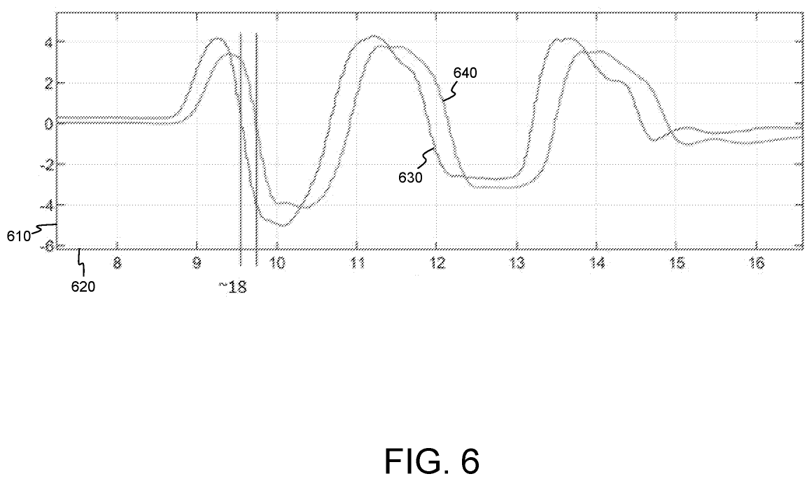

In various examples, the state synchronization module 212 receives as input the conditioned input data 244 generated by the signal conditioning module 210. The state synchronization module 212 performs a state synchronization process to coordinate various estimation inputs and reduce delays and/or mis-synchronization issues. In some examples, the state synchronize process may be performed to reduce a time mismatch between the lateral force rate and the slip angle rate and thereby provide a synchronized slip angle rate. For example, FIG. 6 is a line graph representing an estimated lateral force rate (line 630) and an estimated slip angle rate (line 640) for an exemplary vehicle during a slalom maneuver. The line graph includes time (labeled 620) on the x-axis, and original variables (i.e., derivative of lateral force and derivative of sideslip angle) on the y-axis (labeled 610). As represented, the rates were offset representing a time delay of about 0.18 seconds.

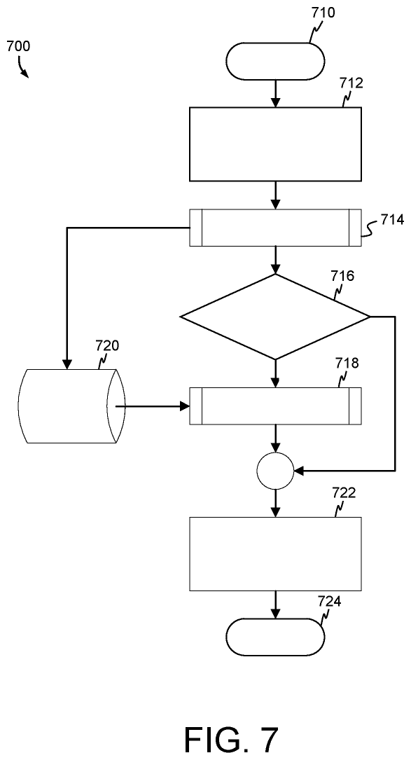

In various examples, the state synchronization module 212 may adjust one or more variables to reduce timing mismatches. For example, FIG. 7 illustrates a method 700 for synchronizing the lateral force rate and the slip angle rate of an exemplary vehicle and thereby providing a synchronized slip angle rate. The method 700 may start at 710. At 712, the method 700 may include obtaining the lateral force rate and the slip angle rate, for example, from the conditioned input data 244. At 714, the method 700 may include determining a time delay between the lateral force rate and the slip angle rate. At 716, the method 700 may include comparing the determined time delay to a time delay threshold (e.g., zero). If the determined time delay is greater than the time delay threshold at 716, the slip angle rate may be modified, at 718, to synchronize with the lateral force rate, for example, the determined time delay (at 720) may be added to the slip angle rate. At 722, the method 700 may include outputting the modified slip angle rate as the synchronized slip angle rate. The method 700 may end at 724. The state synchronization module 212 generates state synchronization data 246 that includes various data indicating the estimated SAT rate, the estimated lateral force rate, and the synchronized slip angle rate.

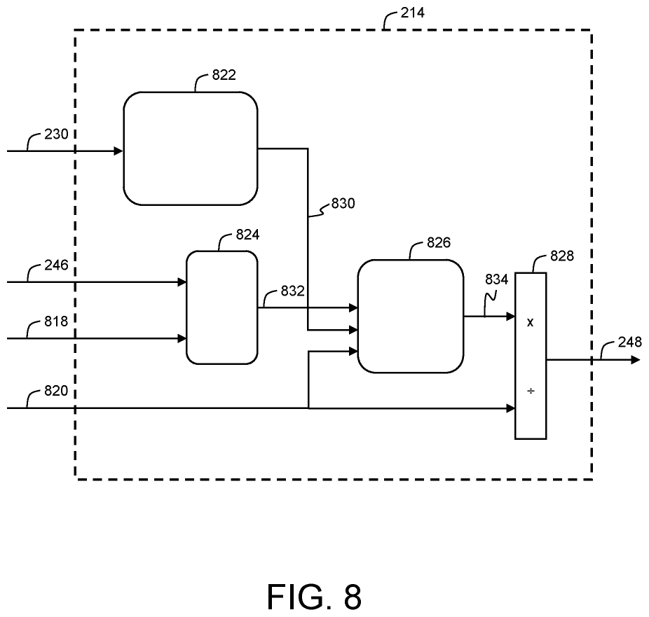

In various examples, the slope estimation module 214 receives as input the state synchronization data 246 generated by the state synchronization module 212. The slope estimation module 214 processes the state synchronization data 246 with a lateral slope submodule 218 to estimate the lateral slope. For example, FIG. 8 illustrates an exemplary operation of the lateral slope submodule 218 for estimating the lateral slope of a vehicle. A reset submodule 822 may receive the sensor data 230 indicating the lateral acceleration (A_{y}), the longitudinal speed (Vₓ), and the normalized lateral force (e.g., Fy/SAT) to determine whether to estimate the lateral slope. In some examples, the reset submodule 822 determines that the lateral slope is to be estimated in response to the absolute values of the lateral acceleration (A_{y}), the longitudinal speed (Vx), and the normalized lateral force being below a calibrated threshold. The reset submodule 822 may generate reset data 830 indicating a decision as to whether to estimate the lateral slope.

An estimator submodule 824 may receive the state synchronization data 246 and may process the state synchronization data 246 to estimate the lateral slope based on the synchronized slip angle rate, the lateral force rate, and the SAT rate. In some examples, the estimator submodule 824 may use an estimator or filter to estimate the lateral slope and thereby reduce noise. Nonlimiting estimators/filters may include a recursive least square estimator or a Kalman filter. In such examples, the estimator submodule 824 may consider any necessary calibration variables while using the estimators/filters (e.g., a recursive least square estimator noise covariance), for example, as indicated by estimator/filter data 818 retrieved from a data storage device (e.g., the data storage device 32). The estimator submodule 824 may generate estimator data 832 indicating the estimated lateral slope (0). A unit delay submodule 826 receives the reset data 830, the estimator data 832, and stiffness data 820 indicating a maximum cornering stiffness. If the reset data 830 indicates that the lateral slope should be estimated/updated, the unit delay submodule 826 uses the estimated lateral slope and the maximum cornering stiffness to produce unit delayed lateral slope data 834. The unit delayed lateral slope data 834 is received by an arithmetic submodule 828 that is configured to normalize the delayed lateral slope with respect to maximum cornering stiffness. The arithmetic submodule 828 may generate estimated lateral slope data 248 indicating a final normalized estimated lateral slope.

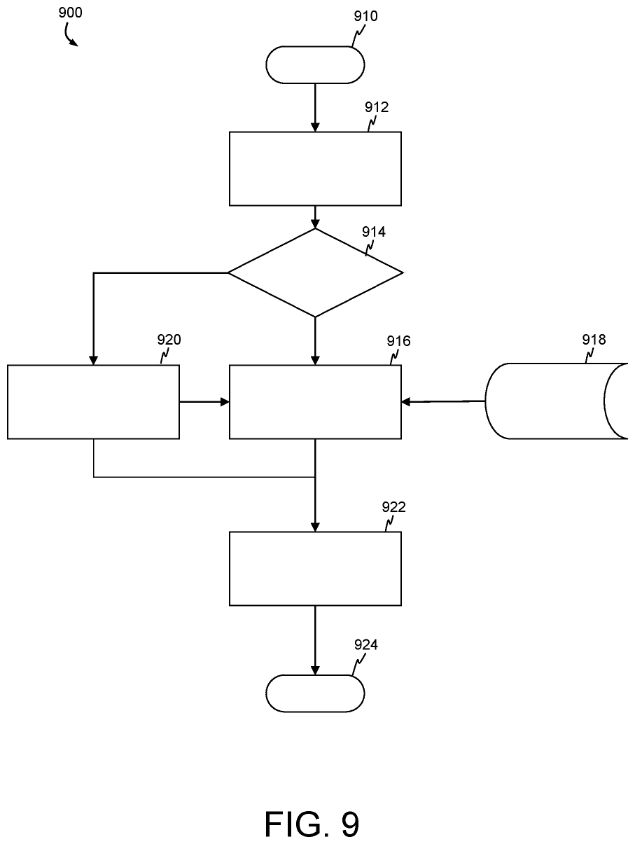

Referring again to FIG. 2, once the lateral slope has been estimated by the estimator submodule 824, a normalization submodule 220 may receive the estimated lateral slope data 248 and normalize the final estimated lateral slope. For example, FIG. 9 illustrates an exemplary method 900 for normalizing the estimated lateral slope of a vehicle. The method 900 may start at 910. At 912, the method 900 includes obtaining the estimated lateral slope, for example, from the estimated lateral slope data 248. At 914, the method 900 may include determining whether the road condition (mu) is available. If available at 914, the method 900 may include normalizing the estimated lateral slope at 916 based on, for example, the road condition (mu) and the normalized stiffness at origin at 918 (i.e., slope estimated at zero sideslip angle). In some examples, the road condition (mu) and the normalized stiffness at origin may be retrieved from a lookup table. If the road condition (mu) is not available at 916, the method 900 may include normalizing the estimated lateral slope without consideration for the road condition (mu) at 920. At 922, the method 900 may include outputting a lateral force slope adhesion level indicator (e.g., between zero and one). The method 900 may end at 924. The normalization submodule 220 may generate normalized data 250 indicating the lateral force slope adhesion level indicator.

The slope estimation module 214 processes the state synchronization data 246 with a SAT slope submodule 222 to estimate the SAT slope. For example, the state synchronization data 246 may be processed through the estimator submodule 824, the unit delay submodule 826, and the arithmetic submodule 828 to calculate the normalized lateral slip slope.

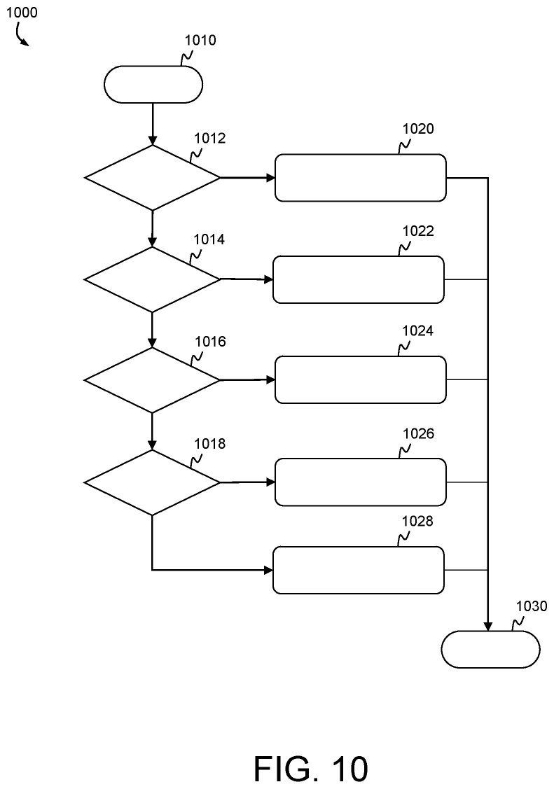

Referring again to FIG. 2, once the SAT rate has been estimated by the SAT slope submodule 222, a classification submodule 224 may receive the estimated SAT slope data 249 and classify the estimated SAT rate. Various classifications and criteria for such classifications may be used. For example, FIG. 10 illustrates a method 1000 for classification of the SAT rate of a vehicle. In this example, the SAT rate is classified as one of four classes including SAT neutral, linear, pre-saturation, and saturation.

The method 1000 may start at 1010. At 1012, the method 1000 may include determining whether conditions are met for the SAT neutral class. For example, the steering wheel angle (SWA) may be compared to a steering wheel angle calibration threshold (e.g., |SWA|>A1), or the steering wheel angle rate may be compared to a steering wheel angle rate calibration threshold (e.g., |SWA rate|>A2). If the conditions are met at 1012, the method 1000 may include classifying the SAT rate as SAT neutral at 1020. If the conditions are not met at 1012, the method 1000 may continue to 1014.

At 1014, the method 1000 may include determining whether conditions are met for the linear class. For example, the SAT slope may be compared to a first SAT slope calibration threshold (e.g., SAT rate>T1>0). If the conditions are met at 1014, the method 1000 may include classifying the SAT rate as linear at 1022. If the conditions are not met at 1014, the method 1000 may continue to 1016.

At 1016, the method 1000 may include determining whether conditions are met for the pre-saturation class. For example, the SAT slope may be compared to a second SAT slope calibration threshold (e.g., |SAT rate|<P1), or the SAT may be compared to a first SAT calibration threshold (e.g., SAT>P2). If the conditions are met at 1016, the method 1000 may include classifying the SAT rate as pre-saturation at 1024. If the conditions are not met at 1016, the method 1000 may continue to 1018.

At 1018, the method 1000 may include determining whether conditions are met for the saturation class. For example, the SAT slope may be compared to a third SAT slope calibration threshold (e.g., SAT rate<S1<0), or the SAT may be compared to a second SAT calibration threshold (e.g., SAT<S2). If the conditions are met at 1018, the method 1000 may include classifying the SAT rate as saturation at 1026. If the conditions are not met at 1018, the method 1000 may include classifying the SAT rate as SAT neutral at 1028. The method 1000 may end at 1030.

The classification submodule 224 may generate classified SAT slope data 252 including various data indicating the classification of the SAT slope.

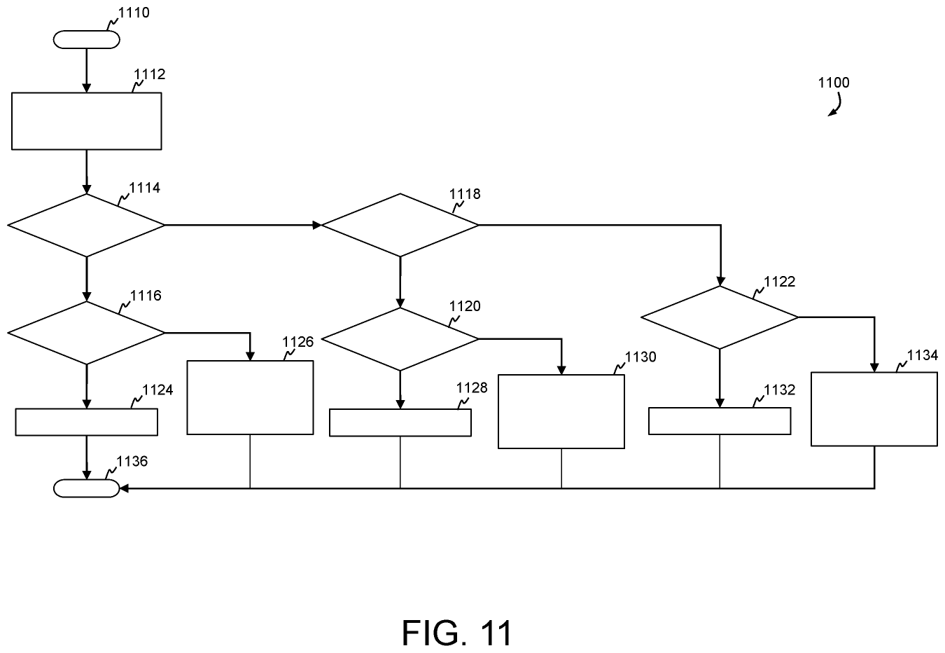

Referring again to FIG. 2, the arbitration and fusion module 216 may receive the normalized data 250 and the classified SAT slope data 252 output by the slope estimation module 214 and process this data to accurately estimate final lateral adhesion levels of the front and rear tires of the vehicle 10. For example, FIG. 11 illustrates a method 1100 for estimating the final lateral adhesion levels for a vehicle. The method 1100 may start at 1110. At 1112, the method 1100 may include obtaining the lateral force slope adhesion level indicator (LFSALI) and the SAT slope classification status, for example, from the normalized data 250 and the classified SAT slope data 252.

At 1114, the method 1100 may include determining whether the SAT slope classification status is saturation. If the classification is saturation at 1114, the method 1100 may include, at 1116, determining whether the lateral force slope adhesion level indicator is less than a first threshold (e.g., 0.2). If the lateral force slope adhesion level indicator is less than the first threshold, the method 1100 may include, at 1124, setting a final lateral adhesion level indicator (FLALI) as being equal to the lateral force slope adhesion level indicator. If the lateral force slope adhesion level indicator is greater than the first threshold at 1116, the method 1100 may include, at 1126, setting the final lateral adhesion level indicator to be equal to the lateral force slope adhesion level indicator multiplied by a first predefined value (e.g., 0.9).

If the classification is not saturation at 1114, the method 1100 may include, at 1118, determining whether the SAT slope classification status is pre-saturation. If the classification is pre-saturation at 1118, the method 1100 may include, at 1120, determining whether the lateral force slope adhesion level indicator is less than a second threshold (e.g., 0.4). If the lateral force slope adhesion level indicator is less than the second threshold, the method 1100 may include, at 1128, setting the final lateral adhesion level indicator as being equal to the lateral force slope adhesion level indicator. If the lateral force slope adhesion level indicator is greater than the second threshold at 1120, the method 1100 may include, at 1130, setting the final lateral adhesion level indicator to be equal to the lateral force slope adhesion level indicator multiplied by a second predefined value (e.g., 0.95).

If the classification is not pre-saturation at 1118, the method 1100 may include, at 1122, determining whether the lateral force slope adhesion level indicator is less than a third threshold (e.g., 0.4). If the lateral force slope adhesion level indicator is less than the third threshold, the method 1100 may include, at 1132, setting the final lateral adhesion level indicator as being equal to the lateral force slope adhesion level indicator. If the lateral force slope adhesion level indicator is greater than the third threshold at 1122, the method 1100 may include, at 1134, setting the final lateral adhesion level indicator to be equal to the lateral force slope adhesion level indicator multiplied by a third predefined value (e.g., 1.1). The method 1100 may end at 1136.

The arbitration and fusion module 216 generates arbitration and fusion data 254 that includes various data indicating the final lateral adhesion level indictor of the front tires and/or a final lateral adhesion level indictor of the rear tires. In some examples, the arbitration and fusion data 254 includes various data indicating pre-saturation warnings for the front tires and/or rear tires. In various examples, the arbitration and fusion module 216 may store the arbitration and fusion data 254 in a database, for example, on the data storage device 32. In various examples, the arbitration and fusion module 216 may transmit the arbitration and fusion data 254 to one or more other systems of the vehicle 10, for example, the steering assistance system 35.

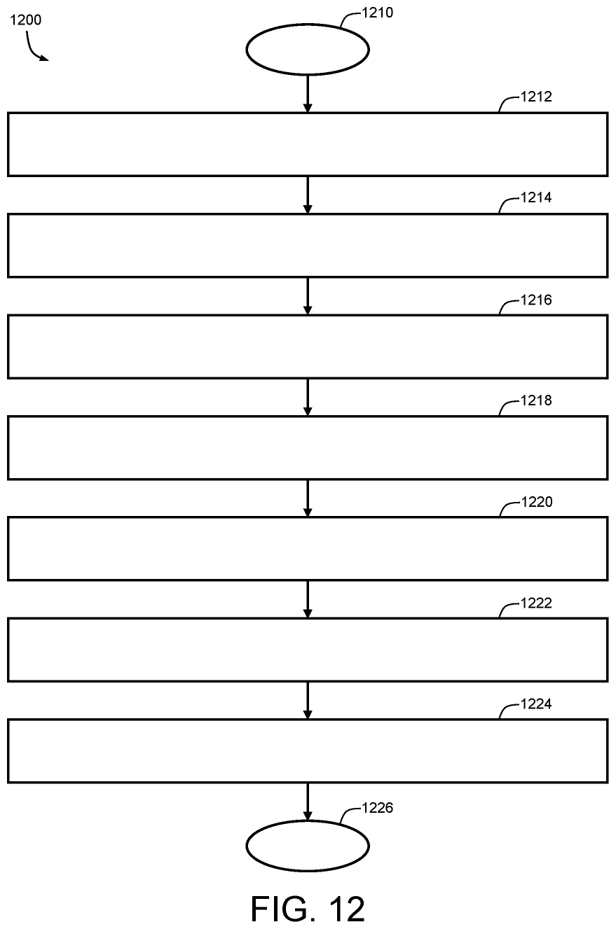

With reference now to FIG. 12 and with continued reference to FIGS. 1-11, a flowchart provides a method 1200 for estimating lateral adhesion level indicators for tires of a vehicle, for example, as performed by the estimation system 100, in accordance with various examples. As can be appreciated in light of the disclosure, the order of operation within the method 1200 is not limited to the sequential execution as illustrated in FIG. 12, but may be performed in one or more varying orders as applicable and in accordance with the present disclosure. In various examples, the method 1200 can be scheduled to run based on one or more predetermined events, and/or can run continuously during operation of the vehicle 10.

In one example, the method 1200 may start at 1210. At 1212, the method 1200 may include receiving signals from an onboard sensor system of the vehicle indicative of operating parameters of the vehicle. At 1214, the method 1200 may include processing the signals to estimate a self-aligning torque rate, a lateral force rate, and a slip angle rate. At 1216, the method 1200 may include performing a state synchronize process to reduce a time mismatch between the lateral force rate and the slip angle rate and thereby provide a synchronized slip angle rate. At 1218, the method 1200 may include performing a filtering process to provide a lateral slope estimation and a self-aligning torque slope estimation each based on the self-aligning torque rate, the lateral force rate, and the synchronized slip angle rate. At 1220, the method 1200 may include performing a normalization process to reduce noise associated with the lateral slope estimation and the self-aligning torque slope estimation and thereby produce a normalized lateral slope estimation and a normalized self-aligning torque slope estimation. At 1222, the method 1200 may include classifying the normalized self-aligning torque slope estimation. At 1224, the method 1200 may include performing an arbitration and fusion process to adjust the normalized lateral slope estimation based on the classification of the normalized self-aligning torque slope estimation to estimate a final lateral adhesion level indicator. The method 1200 may end at 1226.

The systems and methods disclosed herein provide various benefits over certain existing systems and methods. For example, the systems and methods described herein are capable of providing estimations of lateral adhesion levels based on on-board sensor information using multiple fused algorithms, with consideration for the self-aligning torque rate. This allows for reliable estimations for both the front and rear axles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for estimating a lateral adhesion level indicator of tires for a vehicle traveling on tires, comprising:
receiving, with a controller onboard the vehicle, signals from an onboard sensor system of the vehicle indicative of operating parameters of the vehicle;
processing, with one or more processors of the controller, the signals to estimate a self-aligning torque rate, a lateral force rate, and a slip angle rate;
performing, with the one or more processors of the controller, a state synchronize process to reduce a time mismatch between the lateral force rate and the slip angle rate and thereby provide a synchronized slip angle rate;
performing, with the one or more processors of the controller, a filtering process to provide a lateral slope estimation and a self-aligning torque slope estimation each based on the self-aligning torque rate, the lateral force rate, and the synchronized slip angle rate;
performing, with the one or more processors of the controller, a normalization process to reduce noise associated with the lateral slope estimation and the self-aligning torque slope estimation and thereby produce a normalized lateral slope estimation and a normalized self-aligning torque slope estimation;
classifying, with the one or more processors of the controller, the normalized self-aligning torque slope estimation to obtain a classification; and
performing, with the one or more processors of the controller, an arbitration and fusion process to adjust the normalized lateral slope estimation based on the classification of the normalized self-aligning torque slope estimation to estimate the final lateral adhesion level indicator.

2. The method of claim 1, wherein the operating parameters include a lateral force, a steering torque, a longitudinal speed, a lateral acceleration, a yaw rate, steering angles, and various vehicle parameters.

3. The method of claim 1, wherein processing the signals to estimate the self-aligning torque rate is based on a total torque received from a controller area network of the vehicle, a self-aligning torque of the tires, a position and a velocity of the tires, a lumped mass of a steering system of the vehicle, and a lumped dampening of the vehicle.

4. The method of claim 1, wherein processing the signals to estimate the lateral force rate is based on lateral forces of the tires, vertical forces of the tires, and a steering road wheel angle.

5. The method of claim 1, wherein processing the signals to estimate the slip angle rate is based on a longitudinal speed, a lateral acceleration, a yaw rate, one or more vehicle parameters, and a steering wheel angle.

6. The method of claim 1, wherein performing the filtering process to provide the lateral slope estimation and the self-aligning torque slope estimation includes using a recursive least square estimator or a Kalman filter.

7. The method of claim 1, wherein performing the normalization process to reduce the noise associated with the lateral slope estimation and the self-aligning torque slope estimation includes consideration of road conditions.

8. A system for a vehicle, comprising:
a sensor system configured to sense observable conditions of an environment exterior to the vehicle, an interior environment of the vehicle, and/or a condition of one or more components of the vehicle; and
a controller configured to, with one or more processors:
receive signals from the sensor system indicative of operating parameters of the vehicle while traveling on tires;
process the signals to estimate a self-aligning torque rate, a lateral force rate, and a slip angle rate;
perform a state synchronize process to reduce a time mismatch between the lateral force rate and the slip angle rate and thereby provide a synchronized slip angle rate;
perform a filtering process to provide a lateral slope estimation and a self-aligning torque slope estimation each based on the self-aligning torque rate, the lateral force rate, and the synchronized slip angle rate;
perform a normalization process to reduce noise associated with the lateral slope estimation and the self-aligning torque slope estimation and thereby produce a normalized lateral slope estimation and a normalized self-aligning torque slope estimation;
classify the normalized self-aligning torque slope estimation to obtain a classification; and
perform an arbitration and fusion process to adjust the normalized lateral slope estimation based on the classification of the normalized self-aligning torque slope estimation to estimate a final lateral adhesion level indicator.

9. The system of claim 8, wherein the operating parameters include a lateral force, a steering torque, a longitudinal speed, a lateral acceleration, a yaw rate, steering angles, and various vehicle parameters.

10. The system of claim 8, wherein the controller is configured to, by the one or more processors, process the signals to estimate the self-aligning torque rate based on a total torque received from a controller area network of the vehicle, a self-aligning torque of the tires, a position and a velocity of the tires, a lumped mass of a steering system of the vehicle, and a lumped dampening of the vehicle.

11. The system of claim 8, wherein the controller is configured to, by the one or more processors, process the signals to estimate the lateral force rate based on lateral forces of the tires, vertical forces of the tires, and a steering road wheel angle.

12. The system of claim 8, wherein the controller is configured to, by the one or more processors, process the signals to estimate the slip angle rate based on a longitudinal speed, a lateral acceleration, a yaw rate, one or more vehicle parameters, and a steering wheel angle.

13. The system of claim 8, wherein the controller is configured to, by the one or more processors, perform the filtering process to provide the lateral slope estimation and the self-aligning torque slope estimation using a recursive least square estimator or a Kalman filter.

14. The system of claim 8, wherein the controller is configured to, by the one or more processors, perform the normalization process to reduce the noise associated with the lateral slope estimation and the self-aligning torque slope estimation with consideration of road conditions.

15. A vehicle, comprising:
a sensor system configured to sense observable conditions of an environment exterior to the vehicle, an interior environment of the vehicle, and/or a condition of one or more components of the vehicle; and
a controller configured to, with one or more processors:
receive signals from the sensor system indicative of operating parameters of the vehicle while traveling on tires;
process the signals to estimate a self-aligning torque rate, a lateral force rate, and a slip angle rate;
perform a state synchronize process to reduce a time mismatch between the lateral force rate and the slip angle rate and thereby provide a synchronized slip angle rate;
perform a filtering process to provide a lateral slope estimation and a self-aligning torque slope estimation each based on the self-aligning torque rate, the lateral force rate, and the synchronized slip angle rate;
perform a normalization process to reduce noise associated with the lateral slope estimation and the self-aligning torque slope estimation and thereby produce a normalized lateral slope estimation and a normalized self-aligning torque slope estimation;
classify the normalized self-aligning torque slope estimation to obtain a classification; and
perform an arbitration and fusion process to adjust the normalized lateral slope estimation based on the classification of the normalized self-aligning torque slope estimation to estimate a final lateral adhesion level indicator.

16. The vehicle of claim 15, wherein the operating parameters include a lateral force, a steering torque, a longitudinal speed, a lateral acceleration, a yaw rate, steering angles, and various vehicle parameters.

17. The vehicle of claim 15, wherein the controller is configured to, by the one or more processors, process the signals to estimate the self-aligning torque rate based on a total torque received from a controller area network of the vehicle, a self-aligning torque of the tires, a position and a velocity of the tires, a lumped mass of a steering system of the vehicle, and a lumped dampening of the vehicle.

18. The vehicle of claim 15, wherein the controller is configured to, by the one or more processors, process the signals to estimate the lateral force rate based on lateral forces of the tires, vertical forces of the tires, and a steering road wheel angle.

19. The vehicle of claim 15, wherein the controller is configured to, by the one or more processors, process the signals to estimate the slip angle rate based on a longitudinal speed, a lateral acceleration, a yaw rate, one or more vehicle parameters, and a steering wheel angle.

20. The vehicle of claim 15, wherein the controller is configured to, by the one or more processors, perform the normalization process to reduce the noise associated with the lateral slope estimation and the self-aligning torque slope estimation with consideration of road conditions.
